(19) United States
(12) Patent Application Publication
(10) Pub. No.: US 2017/0019585 A1
(43) Pub. Date: Jan. 19, 2017

(54) CAMERA CLUSTERING AND TRACKING SYSTEM

(71) Applicant: AmperVue Incorporated, Los Altos Hills, CA (US)

(72) Inventor: Craig Lytle, Los Altos Hills, CA (US)

(21) Appl. No.: 14/799,797

(22) Filed: Jul. 15, 2015

(51) Int. Cl. H04N 5/232; H04N 5/247; H04N 7/18; H04N 5/77

(52) U.S. Cl. CPC H04N 5/23216; H04N 5/772; H04N 5/247; H04N 5/23206; H04N 5/23212; H04N 5/23296; H04N 7/181

(57) ABSTRACT

Various embodiments provide for a camera clustering and tracking system that can facilitate communications between cameras at an event to coordinate filming and coverage of an event. The camera can identify, locate, and cooperate with other similar cameras in order to share video analytics of the event and coordinate viewing angles to optimize event coverage. The camera can self-select the image they capture by controlling pan, tilt, zoom, focus, iris, frame-rate and/or rotate based on the shared video analytics and can communicate with other cameras through a wireless, wired, infra-red, or audio-modulated communication channel. The camera can analyze the captured video for relevant information and share that data with the other cameras

### TECHNICAL FIELD

The subject disclosure relates to an autonomous camera that can coordinate operations with one or more cameras located nearby to optimize coverage of an event.

### BACKGROUND

Most current video and still cameras are designed to be hand-held or mounted on a tri-pod and controlled by a human operator who is in direct contact with the camera. Most have a viewfinder on the camera to accomplish the task of framing the image. A newer category of point-of-view camera typically lacks the local viewfinder, but are still dependent on the operator to frame the image.

High level sports and performing-art events often hire a crew of professional camera operators all coordinated by a seasoned director to cover the event. The result is a coordinated effort to have each of the many cameras covering a distinct aspect of the event. This produces optimal video coverage for the event, but is too expensive for most events in the world, such as youth sporting and performing-arts events.

The above-described description is merely intended to provide a contextual overview of current techniques for providing remote controlled imaging devices and is not intended to be exhaustive.

### SUMMARY

The following presents a simplified summary in order to provide a basic understanding of some aspects described herein. This summary is not an extensive overview of the disclosed subject matter. It is intended to neither identify key nor critical elements of the disclosure nor delineate the scope thereof. Its sole purpose is to present some concepts in a simplified form as a prelude to the more detailed description that is presented later.

In an example embodiment, a camera device includes a processor and a memory that stores executable instructions that, when executed by the processor, facilitate performance of operations. The operations include determining that the camera is within range of another camera, wherein the other camera is recording an image or video of a common event and forming a camera cluster with the other camera based on feedback received from a user interface. The operations also include determining a location of the other camera and receiving video analytics data from the other camera. The operations also include adjusting operation of the camera, including adjusting at least one of tilt, pan, zoom, and focus based at least in part on the video analytics and the location of the other camera.

In another example embodiment, a method comprises identifying, by a camera device, a camera cluster associated with an event. The method also includes joining, by the camera device, the camera cluster in response to user feedback received from a user interface and determining, by the camera device, a location of another camera device in the camera cluster. The method can also include receiving, by the camera device, video analytics data from the other camera device and adjusting, by the camera device, at least one of viewing angle, zoom, or focus based at least in part on the video analytics data and the location of the other camera device.

In another example embodiment, computer-readable storage device storing executable instructions that, in response to execution, cause a device comprising a processor to perform operations. The operations include identifying a camera cluster associated with an event and joining the camera cluster in response to user feedback received from a user interface. The operations also include determining a location of a camera device in the camera cluster and receiving video analytics data from the camera device. The operations further include adjusting at least one of viewing angle, zoom, or focus based at least in part on the video analytics data and the location of the camera device.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and novel features will become apparent from the following detailed description when considered in conjunction with the drawings.

### BRIEF DESCRIPTION OF THE DRAWINGS

FIG. 1 is a block diagram illustrating an example, non-limiting embodiment of a camera device in accordance with various aspects described herein.

FIG. 2 is a block diagram illustrating an example, non-limiting embodiment of cameras communicating with each other in accordance with various aspects described herein.

FIG. 3 is a block diagram illustrating another example, non-limiting embodiment of a camera clustering and tracking system in accordance with various aspects described herein.

FIG. 4 is a block diagram illustrating another example, non-limiting embodiment of a camera clustering and tracking system in accordance with various aspects described herein.

FIG. 5 is a block diagram illustrating another example, non-limiting embodiment of a camera clustering and tracking system in accordance with various aspects described herein.

FIG. 6 is a block diagram illustrating another example, non-limiting embodiment of a camera clustering and tracking system packet in accordance with various aspects described herein.

FIG. 7 is a block diagram illustrating another example, non-limiting embodiment of a camera clustering and tracking system in accordance with various aspects described herein.

FIG. 8 illustrates a flow diagram of an example, non-limiting embodiment of a method for camera clustering and tracking according to various aspects described herein.

FIG. 9 illustrates a block diagram of an example electronic computing environment that can be implemented in conjunction with one or more aspects described herein.

FIG. 10 illustrates a block diagram of an example data communication network that can be operable in conjunction with various aspects described herein.

### DETAILED DESCRIPTION

The disclosure herein is described with reference to the drawings, wherein like reference numerals are used to refer to like elements throughout. In the following description, for purposes of explanation, numerous specific details are set forth in order to provide a thorough understanding of the subject innovation. It may be evident, however, that various disclosed aspects can be practiced without these specific details. In other instances, well-known structures and devices are shown in block diagram form in order to facilitate describing the subject innovation.

Various embodiments provide for a camera clustering and tracking system that can facilitate communications between cameras at an event to coordinate filming and coverage of an event. The camera can identify, locate, and cooperate with other similar cameras in order to share video analytics of the event and coordinate viewing angles to optimize event coverage. The camera can self-select the image they capture by controlling pan, tilt, zoom, focus, iris, frame-rate and/or rotate based on the shared video analytics and can communicate with other cameras through a wireless, wired, infra-red, or audio-modulated communication channel. The camera can analyze the captured video for relevant information and share that data with the other cameras.

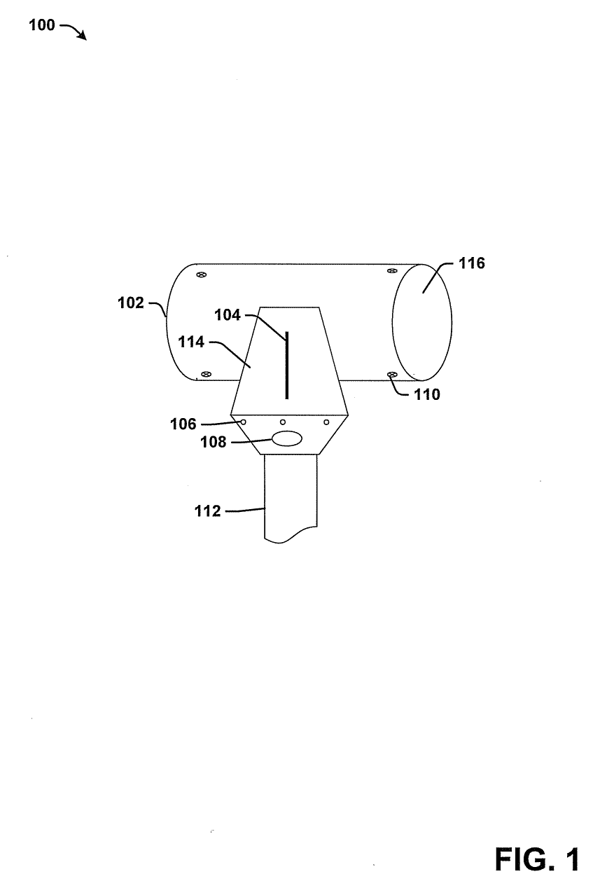

Turning now to the illustrations, FIG. 1 a block diagram illustrating an example, non-limiting embodiment 100 of a camera device 102 in accordance with various aspects described herein.

Camera device 102 can be mounted to a pole or assembly 112 from a tripod or other mounting apparatus. The camera device 102 can rotate around pole 112 and can self rotate via one or more motors within the camera device 102 or can be rotated by a user around the pole 112. In some embodiments, the camera device 102 can also include a mounting assembly 114 that attaches to the pole 112. The mounting assembly 114 can contain one or more motors to rotate the camera around the pole 112 and rotate the camera in an azimuthal direction and increase/decrease the altitude/elevation of the camera device 112.

The camera device 102 can also include microphone inputs 110 in one or more places on the camera device 102 in order to record audio input. The microphone inputs 110 can include microphones and other audio sensors in some embodiments, and in other embodiments, the microphone inputs 110 can include ports to receive a variety of line in inputs from an external microphone. In an embodiment, the microphone inputs 110 can also record audio of an event as well as receive audio or ultrasound signals from other cameras and can facilitate audio based location or audio coupled communication. In an embodiment, the camera device 102 can also include a speaker or speaker port 108. The speaker port can output audio or ultrasound signals that can be received by other cameras to facilitate communication between cameras.

In an embodiment, the camera device 102 can also include infrared or visible light LEDs 106 or other visible modulated indicators that can facilitate communication of the cameras ID and other basic data (location, serial number, operational parameters). The LEDs 106 can communicate information to other cameras such that the other cameras can learn the pan and tilt parameters, zoom parameters, focus parameters, and location information associated with camera device 102 so that the other cameras can identify an object being filmed or tracked by camera device 102. The operations parameters and ID information can also facilitate setting up a camera cluster by identifying the camera.

The camera device 102 can also include a wireless antenna 104 that can facilitate camera to camera communications, camera to user communications, WiFi communications, 3G, 4G, and other mobile network communications or other location services, GPS, and etc. The wireless antenna 104 can facilitate communications between camera device 102 and other camera devices that have wireless antennas. The wireless antenna 104 can also facilitate control of the camera device 102 via a mobile device or other remote controls operated by a user.

The camera device 102 can include one or more sets of lenses 116 that allow the camera device 102 to adjust focus and zoom. The lenses 116 can be associated with one or more image sensors (not shown). In an embodiment, the camera device 102 can include a primary sensor for recording images. The camera device 102 can also include one or more secondary sensors that can be associated with a wide angle set of lenses to enable analytics. The secondary sensor can be used to track and identify objects and a processor can perform analytics on the data, while the primary sensor can be used to record the objects and/or events. The camera device 102 can pan and tilt, and zoom and focus to the object to record with the primary sensor based on image data received by the wide-field secondary sensor. In an embodiment, the camera device 102 can include a wide-angle primary sensor, and objects can be tracked and recorded without requiring pan, tilt, zoom and/or focusing capabilities.

The camera device 102 shown in FIG. 1 and described above is merely an exemplary camera device according to one or more embodiments described herein. In other embodiments, the camera device 102 can include additional features not described above and may also not include some combination of features described above.

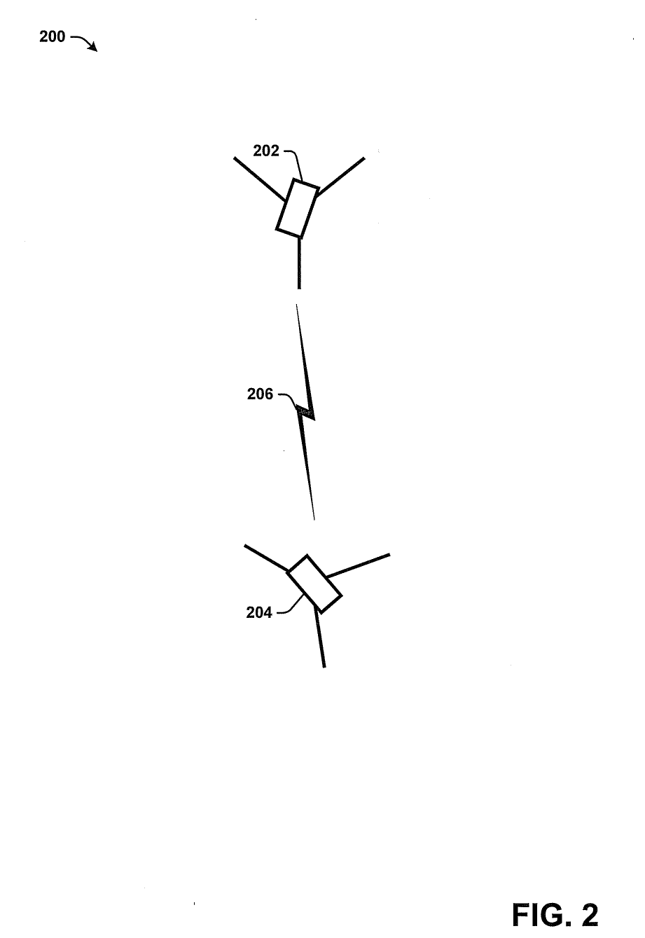

Turning now to FIG. 2, illustrated is a block diagram illustrating an example, non-limiting embodiment 200 of cameras communicating with each other in accordance with various aspects described herein. The cameras 202 and 204 can coordinate and form a camera cluster via one or more communications (e.g., communication 206).

The communication 206 can be via audio, either via modulated sound or ultrasound communications (e.g., via speakers and microphones 108 and 110 respectively). The communication 206 can also be via optical communications (including infrared, visible light, ultraviolet, etc). LEDs or other light sources on the camera devices 202 and 204 (e.g., LED 106) can broadcast information including camera ID and other basic data (location, serial number, operational parameters, etc) to each other and the main camera lens and light sensors (charge coupled device (CCD) chip, CMOS chips, etc) can record the communications and a microprocessor on the camera device 202 or 204 can facilitate interpretation of the light modulated signal.

In other embodiments the camera devices 202 and 204 can communicate with each other via wireless communications such as WiFi, Bluetooth, 3G, 4G, or other mobile network communications systems (e.g., via wireless antenna 104).

In an embodiment, one or more of cameras 202 or 204 can broadcast a signal indicating that the cameras are available to form a cluster with other cameras. In other embodiments, one or more of cameras 202 or 204 can indicate via communication 206 that the camera belongs to a cluster, and provide identifying information about the cluster. The identifying information about the cluster can include a cluster name, names of one or more users associated with the cluster, the name or type of event associated with the cluster, and/or other identifying information.

In an embodiment, camera 202 can send out a beacon 206 via at least one of a wireless, wired, audio coupled, or IR/visible light voupled communication channel. The beacon can include a name of the local cluster that the camera 202 belongs to, as well as other identifying information about any related or associated events. The camera 204 can receive the beacon 206 and send the information to a user via a wireless or wired connection. The user can receive the information via a remote control device or application on a mobile device and indicate whether or not camera 204 should join the cluster associated with camera 202 or form a new cluster. The camera 204 can send back to camera 202 an acknowledgement that camera 204 is joining the cluster. Once the acknowledgement is received by camera 202, camera 202 can then send additional information to camera 204 to coordinate operations with camera 204.

The additional information sent by camera 202 to camera 204 can include information identifying an object or set of objects or events that the camera 202 and the cluster are tracking. The information can also include locations of the other cameras in the cluster as well as operational parameters of the cameras (pan, tilt, zoom, focus, etc). In an embodiment, camera 204 can identify these operational parameters and location information of the cameras in the camera cluster via the audio, visibile/IR or wireless communication channels described above.

The camera 204 can also determine a relative location of each of the other cameras in the cluster and identify a unique vector connecting each camera with each other camera including three degrees of location such as horizontal angle, vertical angle, and distance. These geometries are captured and held internally by each camera in the cluster to facilitate analytics associated with the event. In some embodiments, the camera 204 can identify the locations of the other cameras via receiving GPS locations, wireless signal amplitude based triangulation/multilateration, audio beacon amplitude-based triangulation, or direct image-based detection by controlling the pan-tilt-zoom of each camera to lock onto the light/IR emitting diodes (e.g., LED 106) on each camera. Each camera can share its own location calculations with the whole cluster so that the relative location calculations are more accurate. If a new camera joins the cluster, this location service is repeated, but being careful not to interrupt the coverage of the event by the existing cameras.

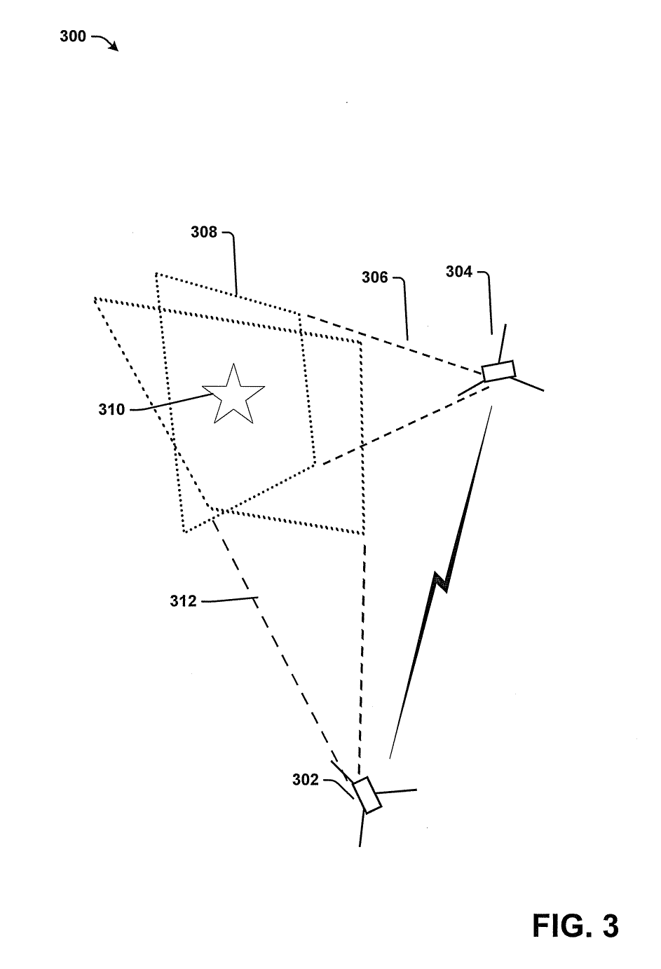

Turning now to FIG. 3, illustrated is a block diagram illustrating another example, non-limiting embodiment of a camera clustering and tracking system 300 in accordance with various aspects described herein.

In system 300, camera devices 302 and 304 can form a cluster that coordinates and optimizes coverage of an event. At the event, object 310 can be an exemplary object of which the camera cluster of camera devices 302 and 304 track and record images and video. Camera device 304 can track or record image or video of object 310, and camera device 302 can identify the object via information received from the camera device 304. In other embodiments camera device 302 can determine the area in which the object 310 that camera device 302 is tracking based on determining a field of view 306 of the camera device 304 and determining a zoom and focus parameters of camera device 304 to identify an area 308 in which the object 310 is located. Camera 302 can then change its field of view 312 by adjusting the pan and tilt of the camera device 302 and the zoom and focus parameters so that the infocus region intersects with area 308 associated with camera device 304.

Camera device 302 can learn the operational parameters of camera device 304 based on one or more of the communication channels described above (IR, audio, wireless, etc). In an embodiment, camera device 302 can receive a packet of information from camera device 304 that includes cluster ID, camera ID, location information of camera 302, event type information, role information, pan, tilt, zoom, focus, object ID, object location, object vector, object color histogram, size, and other information that can be used to locate the object and coordinate tracking of the object and/or event.

Camera device 302 can receive the packet of information from camera 304 and adjust its operation based on the packet of information. Once the area 308 in which the object 310 is located is determined, the object 310 can be identified using the histogram information. The histogram information can include information including a color of the object, and based on that information camera device 302 can identify the object based on matching a histogram to the histogram received from camera device 304.

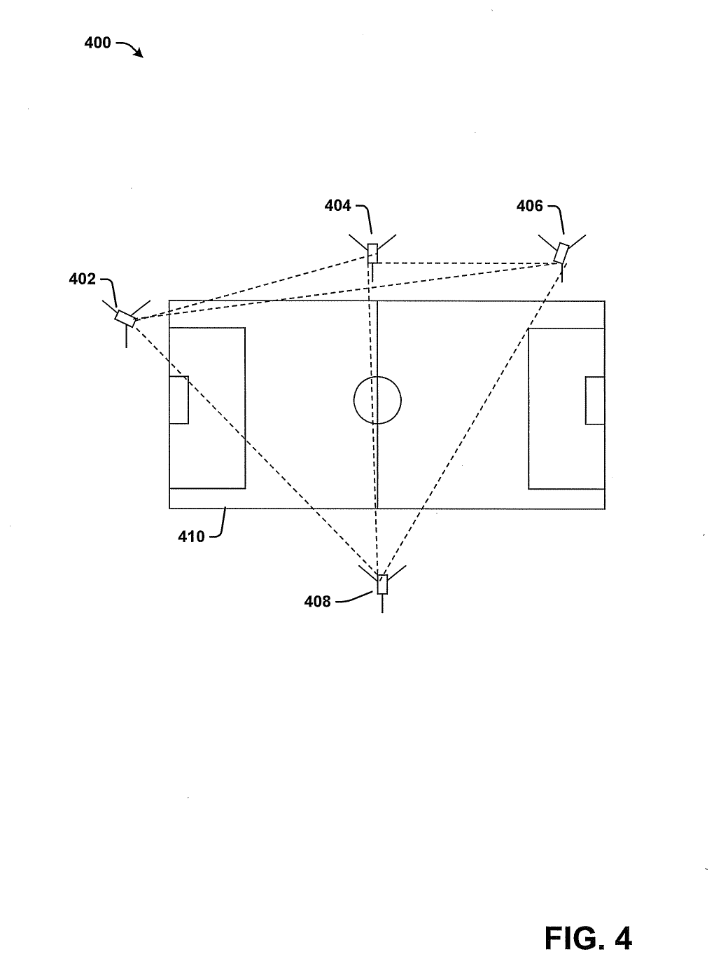

Turning now to FIG. 4, illustrated is a block diagram illustrating another example, non-limiting embodiment of a camera clustering and tracking system 400 in accordance with various aspects described herein. Camera devices 402, 404, 406, and 408 can form a cluster associated with an event (in the embodiment shown in FIG. 4 the event can be a soccer game at a soccer pitch 410) The cameras 402, 404, 406 and 408 can locate each other using audio/ultrasound beacons, LED beacons, or wireless beacons, and learn each others positions, either in absolute terms (GPS coordinates), and/or relative terms. The cameras 402, 404, 406 and 408 can also identify the area associated with the event (soccer pitch 410) and determine which cameras will be closest to the object (e.g., players, ball, etc) on soccer pitch 410, which cameras will have unobstructed views, and other information that can be used to facilitate coverage of the event. The cameras 402, 404, 406 and 408 can also learn each of the other cameras field of view.

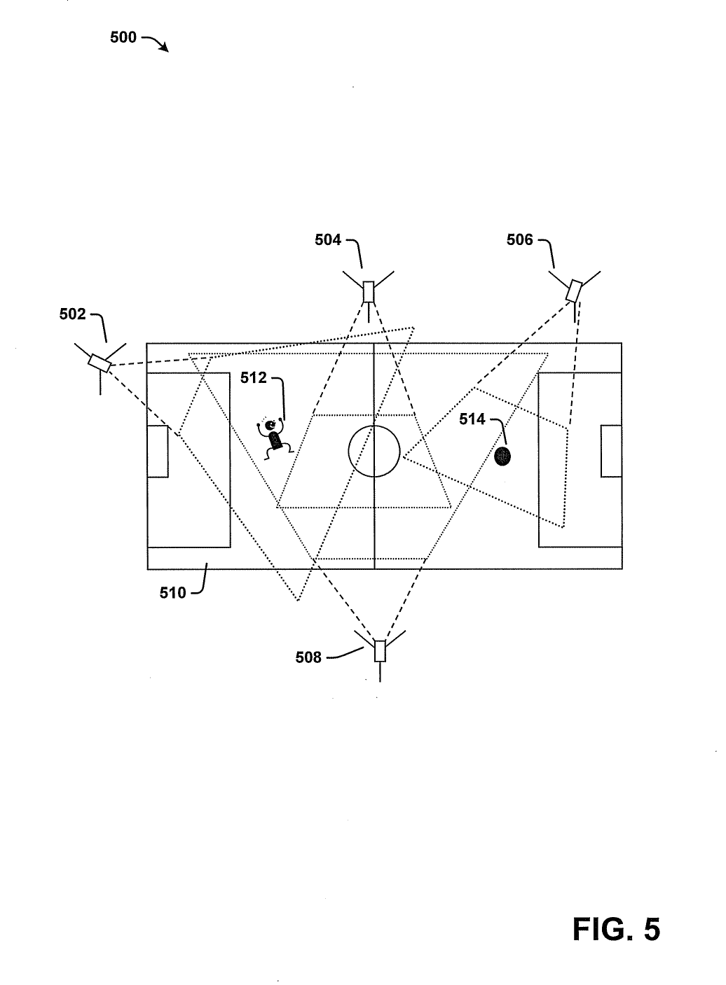

Turning now to FIG. 5, illustrated is a block diagram illustrating another example, non-limiting embodiment of a camera clustering and tracking system 500 in accordance with various aspects described herein. In the embodiment shown in FIG. 5, the cameras 502, 504, 506, and 508, can have learnt each others locations and field of views, and based on that information, each of the cameras in the cluster can have an assigned role based on the event, and where the objects that are being tracked are located (e.g., player 512, and ball 514).

For example, one camera (e.g., camera 508) may track the ball and or player both with a super wide angle while another camera (e.g., camera 504) focuses on just a portion of the field 510 with a tighter zoom. The specific roles are event dependent. Once the event is running, each camera constantly analyzes each frame it's captured for event specific information. For example, a camera (e.g., camera 502) may detect and track specific players in a soccer match (e.g., player 512). Other cameras can track the ball 514 (e.g., camera 506). Once detected, each camera is responsible for broadcasting data related to its local analytics and receiving data broadcast from the other camera. These shared analytics are an important feature that enhances each camera's ability to conduct local analytics and for the cameras collectively to optimally cover the event. Finally, with the local image, local analytics data, and global analytics data, each camera is responsible for updating it's on pan-tilt-zoom plan to continue best complete its assigned role in the global event coverage.

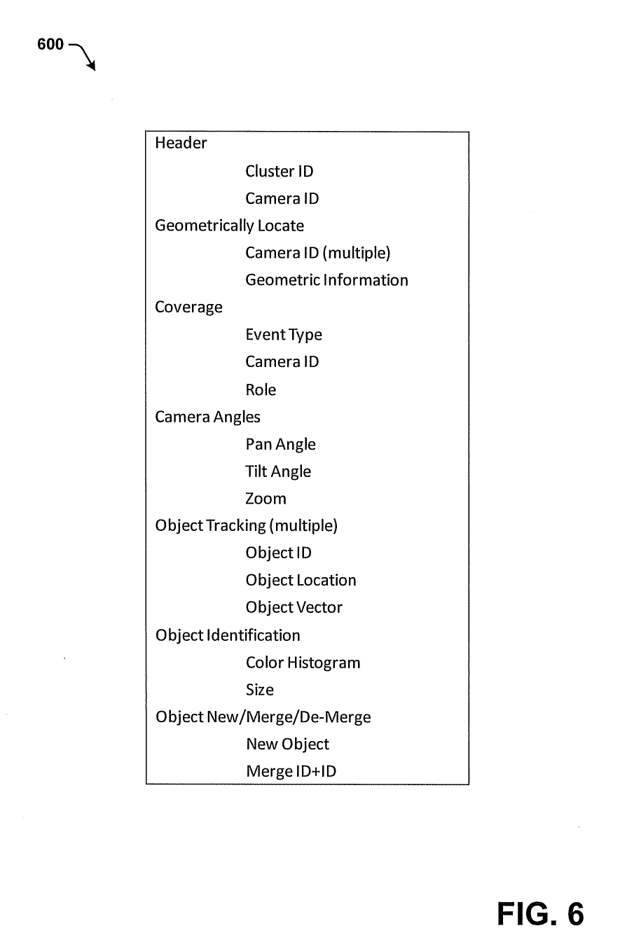

Turning now to FIG. 6, illustrated is a block diagram illustrating another example, non-limiting embodiment of a camera clustering and tracking system packet 600 in accordance with various aspects described herein. As described above, the packet can include a header with a cluster ID and camera ID. The cluster ID can be a name of the cluster, or be a name associated with the event. The camera ID can be a serial number or other identifying information identifying the camera or associated user.

The packet 600 can also include information that can geometrically locate each of the cameras in the cluster and the location information can be tied to each camera ID. The packet 600 can also include coverage information identifying the event, the type of event, roles assigned to one or more of the cameras in the cluster, and other pertinent information. The packet header can also include camera operational parameters such as the pan angle, tilt angle, zoom level, focus, ISO information, aperture information and other operational information such as time spent tracking, etc.

The packet 600 can also include information about the objects being tracked such as the object ID, object location (absolute and relative), and object vector. The packet 600 can also include information that can be used to identify the object such as the size and color histogram information of the object. The packet 600 can be sent via wireless communication channels, or via the audio or visible communication channels using the LED lights, speakers, microphones, etc. In some embodiments, the cameras in the cluster can broadcast the packets to each other and to other cameras at predetermined intervals. In other embodiments, the cameras can transmit the packet to a new camera joining the cluster, or upon a request from one or more cameras in the cluster.

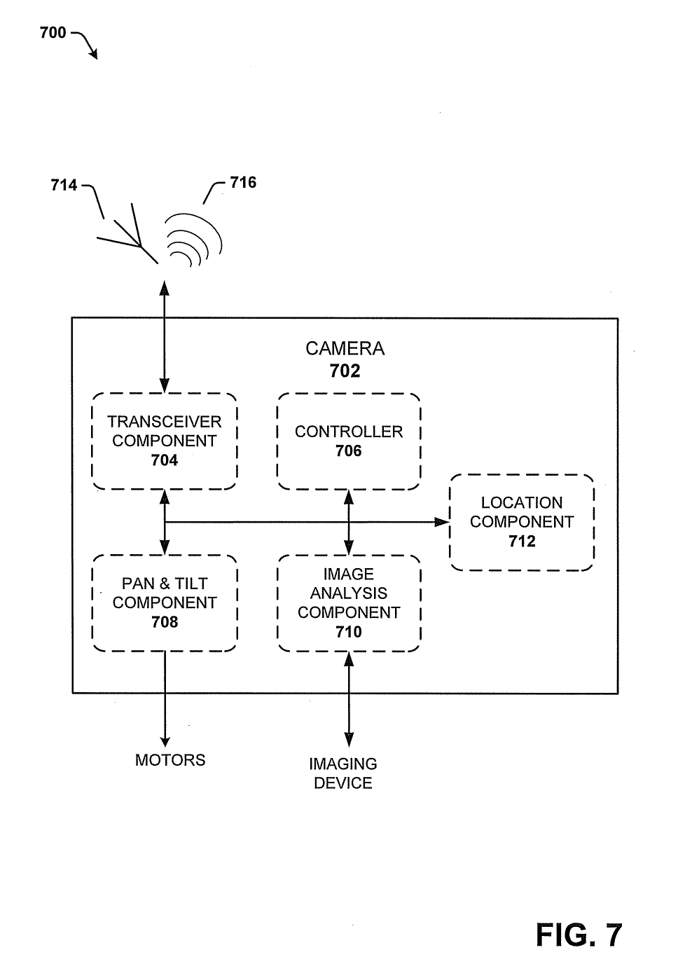

Turning now to FIG. 7, illustrated is a block diagram illustrating another example, non-limiting embodiment of a camera clustering and tracking system 700 in accordance with various aspects described herein.

Camera device 702 can include a transceiver component 704 that can facilitate communications with one or more other camera devices. The transceiver component 704 can communicate with the other camera devices via a wireless antenna 714 or via an audio speaker/microphone 716. In some embodiments, the transceiver component 704 can communicate with the other camera devices via an LED or other light source (not shown).

The controller 706 can receive and translate/decode the communications via the transceiver component 704. Based on the communications received via the transceiver component 704, the controller can determine whether or not the camera device 702 is within range of another camera. If there are other cameras in range, the location component 712 can determine where the cameras are located based on their coordinates in the packet, and can determine relative locations, forming unique vectors between each camera within range. The location component 712 can also determine the location of camera device 702 via mobile network location, GPS, etc, and transceiver component 704 can send the location of camera device 702 to the other cameras nearby.

Based on feedback received from a user interface, the camera device 702 can join and/or form a camera cluster with the other cameras. Once part of the cluster, the transceiver component 704 can send and receive information that can facilitate coordination of tracking objects and events with the other cameras in the cluster.

Transceiver component 704 can receive event analytics (e.g., packet 600) from the other devices, and controller 706 can adjust operation of the camera device 702 based on the location information and the event analytics. The controller 706 can send signals to the pan & tilt component 708 which can adjust the operational parameters of the camera device 702 by activating motors to adjust the pan, tilt, zoom, focus, aperture, shutter speed, and other parameters of the camera.

In an embodiment, if the other camera devices are communicating with the camera device 702 on an optical (visible, IR, etc.) channel, the camera device 702 can receive the information via the main imaging device of the camera device 702. Image analysis component 710 can identify LEDs and other light sources on the other cameras and track the modulation of the LEDs and other light sources to receive the communications from the other camera devices. The controller 706 can decode the light modulations to construct the analytics information from the other cameras.

The image analysis component 710 can also identify other camera devices, and determine their operational parameters (determine where the cameras are directed) based on an analysis of images received via the imaging device on the camera device 702. The location component 712 can also identify the location of the other cameras based on determining a relative location based on a radial angle and elevation angle of the other camera derived from image data from the camera device.

It is to be appreciated that the camera device 702 can both send and receive communications to and from the other cameras via any of the communucations channels disclosed herein. For instance, camera device 702 can send communications via the audio communication channel to a first device, while simultaneously sending a communication to a second device via a wireless communication channel. Similarly, the camera device 702 can also be receiving optical communications via the image analysis component 710 and the imaging device on the camera device 702.

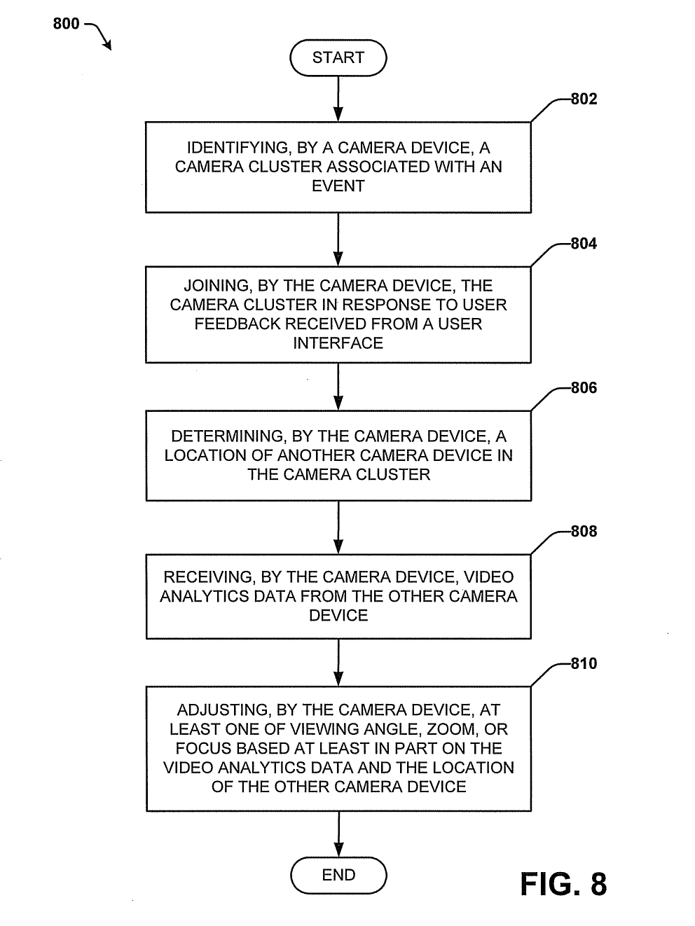

FIG. 8 illustrates processes in connection with the aforementioned systems. The process in FIG. 8 can be implemented for example by systems 100-700 illustrated in FIGS. 1-7 respectively. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 8 illustrates a flow diagram of an example, non-limiting embodiment of a method for operating a front-pivot motorized pan-tilt camera.

Method 800 can start at 802, where the method includes identifying, by a camera device, a camera cluster associated with an event. At 804 the method includes joining, by the camera device, the camera cluster in response to user feedback received from a user interface. At 806 the method includes determining, by the camera device, a location of another camera device in the camera cluster. At 808, the method includes receiving, by the camera device, video analytics data from the other camera device and at 810, the method includes adjusting, by the camera device, at least one of viewing angle, zoom, or focus based at least in part on the video analytics data and the location of the other camera device.

### Example Networking Environment

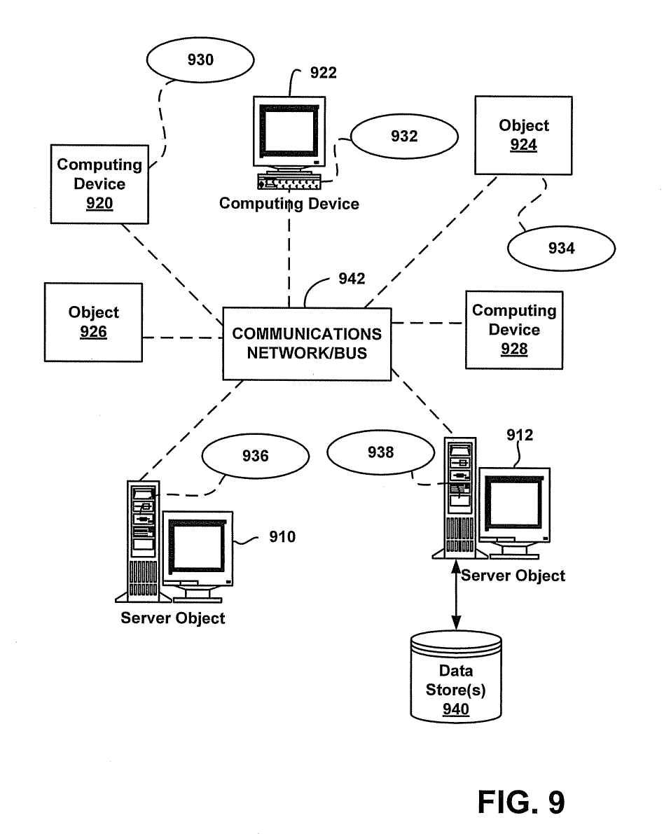

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938 and data store(s) 940. It can be appreciated that computing objects 910, 912, etc. and computing objects or devices 920, 922, 924, 926, 928, etc. may comprise different devices, including a multimedia display device or similar devices depicted within the illustrations, or other devices such as a mobile phone, personal digital assistant (PDA), audio/video device, MP3 players, personal computer, laptop, etc. It should be further appreciated that data store(s) 940 can include one or more cache memories, one or more registers, or other similar data stores disclosed herein.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 942, either directly or indirectly. Even though illustrated as a single element in FIG. 9, communications network 942 may comprise other computing objects and computing devices that provide services to the system of FIG. 9, and/or may represent multiple interconnected networks, which are not shown. Each computing object 910, 912, etc. or computing object or devices 920, 922, 924, 926, 928, etc. can also contain an application, such as applications 930, 932, 934, 936, 938, that might make use of an API, or other object, software, firmware and/or hardware, suitable for communication with or implementation of the techniques and disclosure described herein.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems automatic diagnostic data collection as described in various embodiments herein.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service, in some cases without having to “know” any working details about the other program or the service itself.

In a client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc., acting as servers provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 942 or bus is the Internet, for example, the computing objects 910, 912, etc. can be Web servers with which other computing objects or devices 920, 922, 924, 926, 928, etc. communicate via any of a number of known protocols, such as the hypertext transfer protocol (HTTP). Computing objects 910, 912, etc. acting as servers may also serve as clients, e.g., computing objects or devices 920, 922, 924, 926, 928, etc., as may be characteristic of a distributed computing environment.

### Example Computing Environment

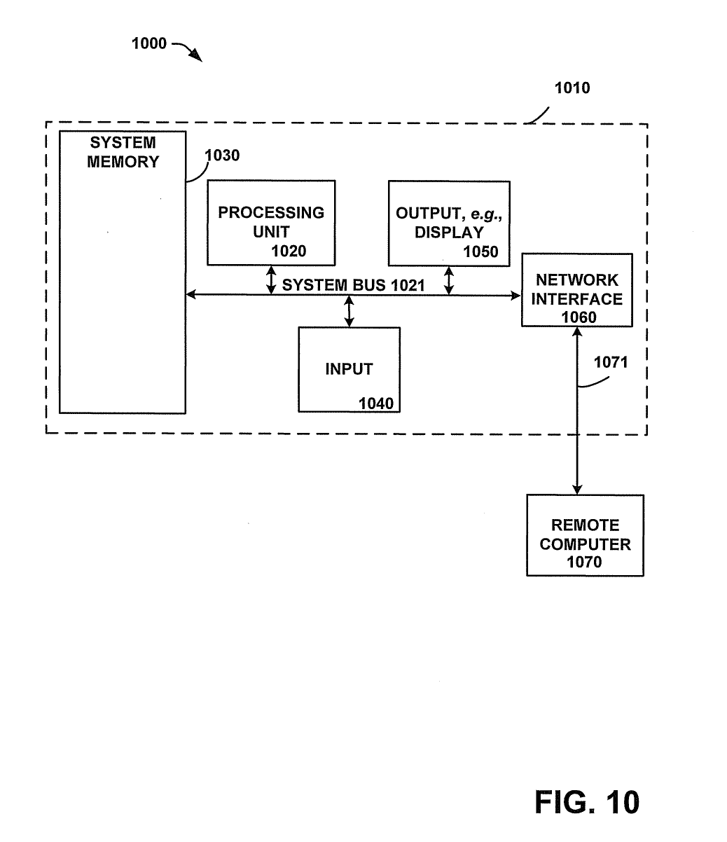

As mentioned, advantageously, the techniques described herein can be applied to any device and/or network where power management is desirable in a multiprocessor system. It is to be understood, therefore, that handheld, portable and other computing devices and computing objects of all kinds are contemplated for use in connection with the various non-limiting embodiments, i.e., the controllers 516, 528, and 702 as described herein. Accordingly, the below general purpose remote computer described below in FIG. 10 is but one example, and the disclosed subject matter can be implemented with any client having network/bus interoperability and interaction. Thus, the disclosed subject matter can be implemented in an environment of networked hosted services in which very little or minimal client resources are implicated, e.g., a networked environment in which the client device serves merely as an interface to the network/bus, such as an object placed in an appliance.

Although not required, some aspects of the disclosed subject matter can partly be implemented via an operating system, for use by a developer of services for a device or object, and/or included within application software that operates in connection with the component(s) of the disclosed subject matter. Software may be described in the general context of computer executable instructions, such as program modules or components, being executed by one or more computer(s), such as projection display devices, viewing devices, or other devices. Those skilled in the art will appreciate that the disclosed subject matter may be practiced with other computer system configurations and protocols.

FIG. 10 thus illustrates an example of a suitable computing system environment 1000 in which some aspects of the disclosed subject matter can be implemented, although as made clear above, the computing system environment 1000 is only one example of a suitable computing environment for a device and is not intended to suggest any limitation as to the scope of use or functionality of the disclosed subject matter. Neither should the computing environment 1000 be interpreted as having any dependency or requirement relating to any one or combination of components illustrated in the exemplary operating environment 1000.

With reference to FIG. 10, an exemplary device for implementing the disclosed subject matter includes a general-purpose computing device in the form of a computer 1010. Components of computer 1010 may include, but are not limited to, a processing unit 1020, a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures.

Computer 1010 typically includes a variety of computer readable media. Computer readable media can be any available media that can be accessed by computer 1010. By way of example, and not limitation, computer readable media can comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1010. Communication media typically embodies computer readable instructions, data structures, program modules, or other data in a modulated data signal such as a carrier wave or other transport mechanism and includes any information delivery media.

The system memory 1030 may include computer storage media in the form of volatile and/or nonvolatile memory such as read only memory (ROM) and/or random access memory (RAM). A basic input/output system (BIOS), containing the basic routines that help to transfer information between elements within computer 1010, such as during start-up, may be stored in memory 1030. Memory 1030 typically also contains data and/or program modules that are immediately accessible to and/or presently being operated on by processing unit 1020. By way of example, and not limitation, memory 1030 may also include an operating system, application programs, other program modules, and program data.

The computer 1010 may also include other removable/non-removable, volatile/nonvolatile computer storage media. For example, computer 1010 could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A hard disk drive is typically connected to the system bus 1021 through a non-removable memory interface such as an interface, and a magnetic disk drive or optical disk drive is typically connected to the system bus 1021 by a removable memory interface, such as an interface.

A user can enter commands and information into the computer 1010 through input devices such as a keyboard and pointing device, commonly referred to as a mouse, trackball, or touch pad. Other input devices can include a microphone, joystick, game pad, satellite dish, scanner, wireless device keypad, voice commands, or the like. These and other input devices are often connected to the processing unit 1020 through user input 1040 and associated interface(s) that are coupled to the system bus 1021, but may be connected by other interface and bus structures, such as a parallel port, game port, or a universal serial bus (USB). A graphics subsystem can also be connected to the system bus 1021. A projection unit in a projection display device, or a HUD in a viewing device or other type of display device can also be connected to the system bus 1021 via an interface, such as output interface 1050, which may in turn communicate with video memory. In addition to a monitor, computers can also include other peripheral output devices such as speakers which can be connected through output interface 1050.

The computer 1010 can operate in a networked or distributed environment using logical connections to one or more other remote computer(s), such as remote computer 1070, which can in turn have media capabilities different from device 1010. The remote computer 1070 can be a personal computer, a server, a router, a network PC, a peer device, personal digital assistant (PDA), cell phone, handheld computing device, a projection display device, a viewing device, or other common network node, or any other remote media consumption or transmission device, and may include any or all of the elements described above relative to the computer 1010. The logical connections depicted in FIG. 10 include a network 1071, such local area network (LAN) or a wide area network (WAN), but can also include other networks/buses, either wired or wireless. Such networking environments are commonplace in homes, offices, enterprise-wide computer networks, intranets and the Internet.

When used in a LAN networking environment, the computer 1010 can be connected to the LAN 1071 through a network interface or adapter. When used in a WAN networking environment, the computer 1010 can typically include a communications component, such as a modem, or other means for establishing communications over the WAN, such as the Internet. A communications component, such as wireless communications component, a modem and so on, which can be internal or external, can be connected to the system bus 1021 via the user input interface of input 1040, or other appropriate mechanism. In a networked environment, program modules depicted relative to the computer 1010, or portions thereof, can be stored in a remote memory storage device. It will be appreciated that the network connections shown and described are exemplary and other means of establishing a communications link between the computers can be used.

As utilized herein, terms “component,” “system,” “architecture” and the like are intended to refer to a computer or electronic-related entity, either hardware, a combination of hardware and software, software (e.g., in execution), or firmware. For example, a component can be one or more transistors, a memory cell, an arrangement of transistors or memory cells, a gate array, a programmable gate array, an application specific integrated circuit, a controller, a processor, a process running on the processor, an object, executable, program or application accessing or interfacing with semiconductor memory, a computer, or the like, or a suitable combination thereof. The component can include erasable programming (e.g., process instructions at least in part stored in erasable memory) or hard programming (e.g., process instructions burned into non-erasable memory at manufacture).

By way of illustration, both a process executed from memory and the processor can be a component. As another example, an architecture can include an arrangement of electronic hardware (e.g., parallel or serial transistors), processing instructions and a processor, which implement the processing instructions in a manner suitable to the arrangement of electronic hardware. In addition, an architecture can include a single component (e.g., a transistor, a gate array, . . . ) or an arrangement of components (e.g., a series or parallel arrangement of transistors, a gate array connected with program circuitry, power leads, electrical ground, input signal lines and output signal lines, and so on). A system can include one or more components as well as one or more architectures. One example system can include a switching block architecture comprising crossed input/output lines and pass gate transistors, as well as power source(s), signal generator(s), communication bus(ses), controllers, I/O interface, address registers, and so on. It is to be appreciated that some overlap in definitions is anticipated, and an architecture or a system can be a stand-alone component, or a component of another architecture, system, etc.

In addition to the foregoing, the disclosed subject matter can be implemented as a method, apparatus, or article of manufacture using typical manufacturing, programming or engineering techniques to produce hardware, firmware, software, or any suitable combination thereof to control an electronic device to implement the disclosed subject matter. The terms “apparatus” and “article of manufacture” where used herein are intended to encompass an electronic device, a semiconductor device, a computer, or a computer program accessible from any computer-readable device, carrier, or media. Computer-readable media can include hardware media, or software media. In addition, the media can include non-transitory media, or transport media. In one example, non-transitory media can include computer readable hardware media. Specific examples of computer readable hardware media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Computer-readable transport media can include carrier waves, or the like. Of course, those skilled in the art will recognize many modifications can be made to this configuration without departing from the scope or spirit of the disclosed subject matter.

What has been described above includes examples of the subject innovation. It is, of course, not possible to describe every conceivable combination of components or methodologies for purposes of describing the subject innovation, but one of ordinary skill in the art can recognize that many further combinations and permutations of the subject innovation are possible. Accordingly, the disclosed subject matter is intended to embrace all such alterations, modifications and variations that fall within the spirit and scope of the disclosure. Furthermore, to the extent that a term “includes”, “including”, “has” or “having” and variants thereof is used in either the detailed description or the claims, such term is intended to be inclusive in a manner similar to the term “comprising” as “comprising” is interpreted when employed as a transitional word in a claim.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Additionally, some portions of the detailed description have been presented in terms of algorithms or process operations on data bits within electronic memory. These process descriptions or representations are mechanisms employed by those cognizant in the art to effectively convey the substance of their work to others equally skilled. A process is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise or apparent from the foregoing discussion, it is appreciated that throughout the disclosed subject matter, discussions utilizing terms such as processing, computing, calculating, determining, or displaying, and the like, refer to the action and processes of processing systems, and/or similar consumer or industrial electronic devices or machines, that manipulate or transform data represented as physical (electrical and/or electronic) quantities within the registers or memories of the electronic device(s), into other data similarly represented as physical quantities within the machine and/or computer system memories or registers or other such information storage, transmission and/or display devices.

In regard to the various functions performed by the above described components, architectures, circuits, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In addition, while a particular feature may have been disclosed with respect to only one of several implementations, such feature may be combined with one or more other features of the other implementations as may be desired and advantageous for any given or particular application. It will also be recognized that the embodiments include a system as well as a computer-readable medium having computer-executable instructions for performing the acts and/or events of the various processes.

Other than where otherwise indicated, all numbers, values and/or expressions referring to quantities of items such as memory size, etc., used in the specification and claims are to be understood as modified in all instances by the term “about.”

What is claimed is:

1. A camera device, comprising:
a processor; and
a memory that stores executable instructions that, when executed by the processor, facilitate performance of operations, comprising:
determining that the camera is within range of another camera, wherein the other camera is recording an image or video of a common event;
forming a camera cluster with the other camera based on feedback received from a user interface;
determining a location of the other camera;
receiving video analytics data from the other camera; and
adjusting operation of the camera, comprising adjusting at least one of tilt, pan, zoom, and focus based at least in part on the video analytics and the location of the other camera.

2. The camera device of claim 1, wherein the video analytics data comprises an object location, an object vector, object color histogram information, object size information, a pan angle, a tilt angle, and zoom and focus information.

3. The camera device of claim 1, wherein the location of the other camera is based on global positioning coordinates received from the other camera.

4. The camera device of claim 1, wherein the location of the other camera is based on determining a relative location based on a radial angle and elevation angle of the other camera derived from image data from the camera device.

5. The camera device of claim 1, wherein the operations further comprise:
determining a viewing angle of the other camera.

6. The camera device of claim 5, wherein the operations further comprise:
determining a camera role for the camera device based at least in part on the video analytics and the location of the other camera.

7. The camera device of claim 6, wherein the operations further comprise:
determining a camera role for the other camera based at least in part on the video analytics and the location of the other camera; and
transmitting camera role information for the other camera to the other camera.

8. The camera device of claim 1, wherein the operations further comprise:
receiving a packet of information from the other camera, wherein the packet of information comprises the video analytics data, and status information.

9. The camera device of claim 8, wherein the receiving the packet of information comprises receiving the packet of information from the other camera using at least one of a wireless connection, line of sight connection, or audio connection.

10. The camera device of claim 1, wherein the operations further comprise:
determining an object location of an object based on image data from the camera device, wherein the object location comprises location information relative to the other camera.

11. The camera device of claim 10, wherein the operations further comprise:
identifying the object based on color histogram information.

12. A method, comprising:
identifying, by a camera device, a camera cluster associated with an event;
joining, by the camera device, the camera cluster in response to user feedback received from a user interface;
determining, by the camera device, a location of another camera device in the camera cluster;
receiving, by the camera device, video analytics data from the other camera device; and
adjusting, by the camera device, at least one of viewing angle, zoom, or focus based at least in part on the video analytics data and the location of the other camera device.

13. The method of claim 12, wherein the determining the location of the other camera device comprises determining the location based on location coordinates received from the other camera device or based on determining a relative location based on a radial angle and elevation angle of the other camera derived from image data from the camera device

14. The method of claim 12, further comprising:
determining a viewing angle of the other camera based on image data from the camera device.

15. The method of claim 12, further comprising:
selecting, by the camera device, a camera role based at least in part on the video analytics and the location of the other camera device.

16. The method of claim 12, further comprising:
determining, by the camera device, a camera role for the other camera device based at least in part on the video analytics and the location of the other camera device; and
transmitting, by the camera device, camera role information for the other camera device to the other camera device.

17. The method of claim 12, further comprising:
determining, by the camera device, an object location of an object based on image data associated with the camera device, wherein the object location comprises location information relative to the other camera device.

18. A computer-readable storage device storing executable instructions that, in response to execution, cause a device comprising a processor to perform operations, comprising:
identifying a camera cluster associated with an event;
joining the camera cluster in response to user feedback received from a user interface;
determining a location of a camera device in the camera cluster;
receiving video analytics data from the camera device; and
adjusting at least one of viewing angle, zoom, or focus based at least in part on the video analytics data and the location of the camera device.

19. The computer-readable storage device of claim 18, wherein the operations further comprise:
determining a camera role for the camera device based at least in part on the video analytics and the location of the other camera and a location of a subject associated with the event.

20. The computer-readable storage device of claim 19, wherein the operations further comprise:
determining the subject location based at least in part on image data associated with the camera device and the video analytics data.
